(19) United States
(12) Patent Application Publication
(10) Pub. No.: US 2023/0252379 A1
(43) Pub. Date: Aug. 10, 2023

(54) GOODS MANUFACTURING SUPPLY CHAIN DATA COLLECTION AND MANAGEMENT

(71) Applicant: Bättra, LLC, McLean, VA (US)

(72) Inventor: Adam Barford, McLean, VA (US)

(21) Appl. No.: 17/592,864

(22) Filed: Feb. 4, 2022

(51) Int. Cl. G06Q 10/06; G06Q 50/04

(52) U.S. Cl. CPC G06Q 10/06315; G06Q 50/04

(57) ABSTRACT

A method and system of managing a manufacturing supply chain, related to the manufacture of an end product, is described. The method and system includes receiving from the manufacturer of the end product information including contact information regarding a plurality of suppliers, each of which supplies a specific component or material used in the manufacture of the end product; and information regarding the specific component or material supplied by each respective supplier. The method and system utilizes received information to automatically and electronically communicate with each of the plurality of suppliers, to invite each of the plurality of suppliers to verify that the first and/or second information received is correct; and when at least one of the plurality of suppliers has verified the first and/or second information as correct, sending an invitation to the at least one supplier.

### FIELD OF THE DISCLOSURE

The present disclosure relates to the technical field of manufacturing of goods in factories, manufacturing plants or the like, and more specifically to systems, servers, methods and devices for computing and providing enhanced functionality in the management of supply chains related to such manufacturing.

### BACKGROUND

When an overall product (such as a smart phone, or other electronic device) is being manufactured in a physical facility such as a factory or manufacturing plant, the facility requires sub-components to be delivered to the facility from one or more separate facilities (separate manufacturing plant(s)) where such sub-components are being manufactured/assembled. These sub-components are taken as inputs and used by the facility building the overall product, in the manufacture of the overall product. For example, a sub-component could be a battery and the overall product could be a smart phone. The manufacturer of the smart phone would take the battery as an input and use it in the overall manufacture of the smart phone.

Likewise, the facility that manufactures the sub-component (the battery in the example above) also requires sub-components to be delivered from another supplier further upstream (for example, the battery manufacturer requires chemicals to be delivered to the battery manufacturer from a chemicals supplier, so that the battery manufacturer can use those chemicals in the manufacture of the battery).

Still further upstream, the manufacturer of the chemicals also has its own suppliers.

This overall relationship between suppliers/manufacturers is known as a supply chain. Management of the supply chain is very important in terms of managing the timing and cost for the manufacture of the overall product (e.g., the smart phone in the example above). Any problems or delays upstream in the supply chain can affect the timing of delivery of the overall product to customers.

However, management of the supply chain requires detailed information regarding each of the upstream tiers in the supply chain. Each supplier in each tier has its own customers (located downstream from a particular supplier) and its own suppliers (located upstream from that particular supplier). But a manufacturer rarely has information about the upstream tiers of suppliers and the customers and suppliers for each such tier.

Accordingly, the present disclosure recognizes that the current state of the art does not provide for an efficient way of solving technical problems associated with the management of a supply chain for use in the manufacture of a product in a factory.

### BRIEF SUMMARY

In some implementations, the techniques described herein relate to a method of managing a manufacturing supply chain, related to the manufacture of an end product, comprising: receiving from a client computer system used by a manufacturer of the end product, first information including contact information regarding a plurality of suppliers, each of which supplies a specific component or material used in the manufacture of the end product; and second information regarding the specific component or material supplied by each respective supplier; using the first information to automatically and electronically communicate with a client computer system used by each of the plurality of suppliers, to invite each of the plurality of suppliers to verify that the first and/or second information received is correct; when at least one of the plurality of suppliers has verified, via its respective client computer system, the first and/or second information as correct, sending an invitation to the client computer system used by at least one supplier, inviting the at least one supplier to provide third information including contact information regarding a plurality of suppliers, each of which supplies to the at least one supplier, a specific component or material used in the manufacture of the component or material that the at least one supplier supplies to the manufacturer of the end product; and fourth information regarding the specific component or material supplied to the at least one supplier, by its respective supplier; receiving at least one response to the invitation or invitations; repeating the sending of invitations based on contents of the at least one response and receiving responses to respective invitations; using information included in the responses to create a data model; and performing analysis of the data model to develop insights useful in managing the supply chain.

The present disclosure provides for the collection and verification of detailed information regarding a supply chain in a very efficient manner.

Because the information is automatically collected and organized into a data model, the data model can then be processed using analytics without having to create the model by programming using an event simulation programming tool, and therefore, as the data model changes dynamically (for example, as new suppliers provide their information regarding their suppliers and the materials or products that are supplied by them) no new programming is required to take advantage of the updated model in performing analytics to discover insights regarding the entire supply chain. Accordingly, it can be no longer necessary for a simulation analyst to update the simulation model with new model elements, including updating code and then running the new analysis. Because the supply chain information is collected automatically, modeling time is greatly reduced. In addition, it is a very flexible model, and even allows analytics to be processed when there are information gaps. A supply chain map can be easily viewed, showing the participants in the supply chain, and more advanced analytics can be modeled. This can also greatly save on technical resources in terms of processing time of the computer hardware involved, due to the elimination of the new programming and extra running of the processor, that would otherwise be required.

The data model can be acted on by analytics algorithms to generate insights which are very useful to improving the manufacturing process of an end product in a factory or manufacturing plant. Specifically, the manufacturing process can be improved by providing valuable insights into delays and extra costs associated with the manufacturing plants of suppliers located upstream in a supply chain. These insights can be taken into account during the manufacturing process of the overall end product (e.g., a smart phone), to improve planning of the manufacturing process, ultimately resulting in the better and more efficient manufacturing of the overall end product. Accordingly, the manufacturing process taking place in the factory is improved, due to the innovative way in which the information regarding the suppliers is collected according to the present disclosure. Also, risks and vulnerabilities in the supply chain can be more easily identified. For example, previously unknown suppliers can be seen in a supply chain (so that, for example, they could be vetted where previously they were unknown and this vetting would not have been possible). As another example, these previously unknown suppliers in the supply chain can be analyzed to determine which countries they come from, so that risks related to foreign sources can be easily identified. Further, a reliance on single or sole source suppliers can also be identified. These risk insights can inform strategic sourcing and supplier relationship management processes and contingency planning.

In some implementations, a supplier responds to an invitation using a web-based form which is part of an application which carries out the method. This makes it very simple for the supplier to respond to the invitation.

In some implementations, new invitations are sent automatically as new suppliers are added. This allows the resulting data model to dynamically change/grow/contract as the supply chain evolves over time.

In some implementations, the data model is stored in a database and is timestamped. The time stamps can be used to advantage during the data analytics processing.

In some implementations, the application allows the supplier to use the web-based form to edit information in preparing a response to an invitation. This provides flexibility and accuracy in the data model collection process, whereby, if the sender of the invitation has made an error, this can be corrected by the supplier when replying to the invitation.

In some implementations, the application allows the supplier to edit a previously submitted response to an invitation. This saves the supplier much time in having to recreate a response which is identical to a previously submitted response to a previous invitation.

In some implementations, the application uses a plurality of factors to determine if a new invitation is similar to a previously submitted response to an invitation, including any of an email address of a sender of an invitation, an identity of a product or material, and an identity of the end product and prompts the supplier to edit a previously submitted response to an invitation when a new invitation is determined to be similar to a previously received invitation. This saves the supplier much time in having to recreate a response which is not identical to a previously submitted response to a previous invitation, but which is very similar thereto.

In some implementations, the application allows a supplier to have visibility of that supplier’s upstream supplier relationships and prevents a supplier from having visibility of that supplier’s downstream relationships. This maintains confidentiality/secrecy with respect to a party’s downstream relationships. For example, a manufacturer of an end product (smart phone) may not want its battery supplier to know all of the other suppliers (e.g., which touch screen providers) the manufacturer of the end product is using, as this may be sensitive trade secret confidential information.

In some implementations, the disclosure also provides a computer system for managing a manufacturing supply chain, related to the manufacture of an end product, the computer system comprising: a bus system; a storage device connected to the bus system, wherein the storage device stores program instructions; and a processor connected to the bus system, wherein the processor executes the program instructions to carry out a method comprising: receiving from a client computer system used by a manufacturer of the end product, first information including contact information regarding a plurality of suppliers, each of which supplies a specific component or material used in the manufacture of the end product; and second information regarding the specific component or material supplied by each respective supplier; using the first information to automatically and electronically communicate with a client computer system used by each of the plurality of suppliers, to invite each of the plurality of suppliers to verify that the first and/or second information received is correct; when at least one of the plurality of suppliers has verified, via its respective client computer system, the first and/or second information as correct, sending an invitation to the client computer system used by at least one supplier, inviting the at least one supplier to provide third information including contact information regarding a plurality of suppliers, each of which supplies to the at least one supplier, a specific component or material used in the manufacture of the component or material that the at least one supplier supplies to the manufacturer of the end product; and fourth information regarding the specific component or material supplied to the at least one supplier, by its respective supplier; receiving at least one response to the invitation or invitations; repeating the sending of invitations based on contents of the at least one response and receiving responses to respective invitations; using information included in the responses to create a data model; and performing analysis of the data model to develop insights useful in managing the supply chain.

Further, in other some implementations, the disclosure provides a computer program product for managing a manufacturing supply chain, related to the manufacture of an end product, the computer program product comprising a computer readable storage medium having program instructions embodied therewith, the program instructions executable by a computer to cause the computer to perform a method comprising: receiving from a client computer system used by a manufacturer of the end product, first information including contact information regarding a plurality of suppliers, each of which supplies a specific component or material used in the manufacture of the end product; and second information regarding the specific component or material supplied by each respective supplier; using the first information to automatically and electronically communicate with a client computer system used by each of the plurality of suppliers, to invite each of the plurality of suppliers to verify that the first and/or second information received is correct; when at least one of the plurality of suppliers has verified, via its respective client computer system, the first and/or second information as correct, sending an invitation to the client computer system used by at least one supplier, inviting the at least one supplier to provide third information including contact information regarding a plurality of suppliers, each of which supplies to the at least one supplier, a specific component or material used in the manufacture of the component or material that the at least one supplier supplies to the manufacturer of the end product; and fourth information regarding the specific component or material supplied to the at least one supplier, by its respective supplier; receiving at least one response to the invitation or invitations; repeating the sending of invitations based on contents of the at least one response and receiving responses to respective invitations; using information included in the responses to create a data model; and performing analysis of the data model to develop insights useful in managing the supply chain.

Further, in some other implementations, the disclosure provides a system for managing a manufacturing supply chain, the system comprising: at least one processor; and at least one memory that stores computer executable instructions, wherein, when the computer executable instructions are executed by the at least one processor, the at least one processor is configured to: receive from a first node a plurality of first information and a plurality of second information associated with a plurality of other nodes, wherein the plurality of first information comprises contact information associated with the plurality of other nodes, wherein the plurality of second information comprises at least one component used in the manufacture supplied by the plurality of other nodes: automatically and electronically communicate with the plurality of other nodes, using the plurality of first information, to invite the plurality of other nodes to verify that first and second information is correct; send an electronic invitation to at least one of the plurality of other nodes requesting that the at least one of the plurality of other nodes provide a third information and a fourth information, wherein the third information comprises contact information of at least one new node, wherein the at least one new node provides a component used in the manufacture of the component that the at least one of the plurality of other nodes supplies to first node, and the fourth information comprises a component supplied to the at least one of the plurality of other nodes by the at least one new node; create a data model based on the first information, the second information, the third information, and the fourth information; determine a minimum capacity node based on the data model; and adjust a supply chain input at a node based on the determined minimum capacity node.

In some implementations, the computer executable instructions further cause the at least one processor to collect lead time information from a node specifying a time required for the node to complete an entire production run, and to include the collected lead time information in the data model.

In some implementations, the computer executable instructions further cause the at least one processor to collect capacity information from a node regarding a number of units that can be produced within a unit of time, or time unit interval, such as a specific time interval measured in minutes, hours or days, and to include the collected capacity information in the data model.

In some implementations, the computer executable instructions further cause the at least one processor to calculate a total lead time along a path in the supply chain.

### BRIEF DESCRIPTION OF THE DRAWINGS

FIG. 1 is a flowchart showing a method according to some implementations of the disclosure.

FIG. 2 is a flowchart showing a method according to some implementations of the disclosure.

FIG. 3 is a flowchart showing a method according to some implementations of the disclosure.

FIG. 4 is a block diagram illustrating a client/server computing architecture according to some implementations of the disclosure.

FIG. 5 is a block diagram illustrating program instruction modules according to some implementations of the disclosure.

FIG. 6 is a block diagram of a data flow of an example supply chain and manufacturing critical path.

### DETAILED DESCRIPTION

It is to be understood that the disclosure is not limited in its application to the details of construction and the arrangement of components set forth in the following description or illustrated in the following drawings. The features described in the disclosure are capable of other implementations and of being practiced or of being carried out in various ways. Also, it is to be understood that the phraseology and terminology used herein is for the purpose of description and should not be regarded as limiting.

The following discussion is presented to enable a person skilled in the art to make and use implementations of the disclosure. Various modifications to the illustrated implementations will be readily apparent to those skilled in the art, and the generic principles herein can be applied to other implementations and applications without departing from implementations of the disclosure. Thus, implementations of the disclosure are not intended to be limited to implementations shown but are to be accorded the widest scope consistent with the principles and features disclosed herein. The following detailed description is to be read with reference to the figures, in which like elements in different figures have like reference numerals. The figures, which are not necessarily to scale, depict selected implementations and are not intended to limit the scope of implementations of the disclosure. Skilled artisans will recognize the examples provided herein have many useful alternatives and fall within the scope of implementations of the disclosure.

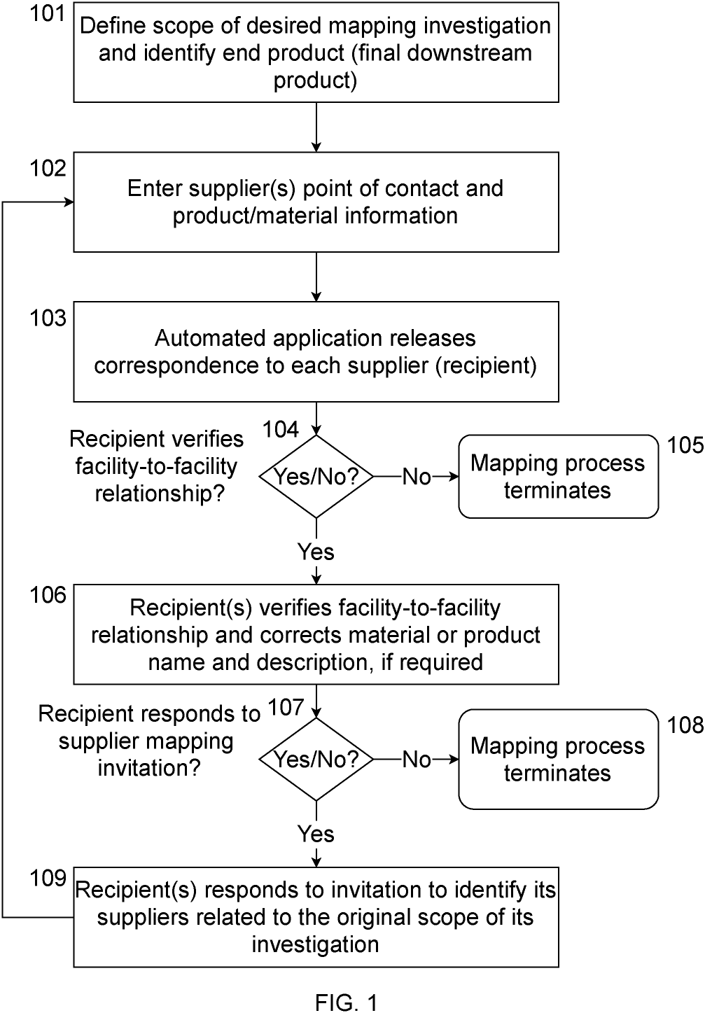

This disclosure discusses an automated process for collecting, mapping and processing the upstream facility-to-facility (or, more generally, node-to-node) (a node could be a facility but a node could also be 10 manufacturing processes within a facility) relationships of an extended supply chain network in the context of an overall end customer product and/or material. There is no limit to the number of supply chain tiers or upstream relationships that can be mapped. In some implementations, the process works as follows, with reference to the flow chart of FIG. 1.

At the first functional block 101 in FIG. 1, the scope of the desired mapping investigation is defined, such as identifying a particular end product that is to be manufactured at the point furthest downstream in the supply chain (e.g., the smart phone in the example given above), and once this is done, at the next functional block 102 of FIG. 1, a customer (e.g., the smart phone manufacturer) enters the point of contact information for its suppliers (e.g., the battery manufacturer, the touch screen manufacturer, etc.) covered within the scope of the desired mapping investigation. In some implementations, point of contact information can include email, text, or a physical mailing address. In one possible implementation, point of contact information can be an email address; however, other types of point of contact information for correspondence such as a social media account for messaging over social media, or a number for text messaging are also possible means. It should be appreciated that any suitable point of contact information allowing for contact with a supplier may be utilized.

Also as part of the functional block 102, in some implementations, the customer identifies the material or product provided by each supplier by entering a name and description of the material provided by the supplier (e.g., battery, touch screen, etc.).

At the next functional block 103, the automated process, which could be implemented as a software application, uses the information provided as just described above and releases correspondence to each supplier (recipient). In one implementation, this correspondence can be an invitation (also referred to herein as a mapping invitation) for each supplier to provide contact information for that supplier’s suppliers (further upstream in the supply chain), thereby creating a link in a facility-to-facility supply chain relationship. As discussed herein, a supply chain link is formed between two nodes (e.g., suppliers) in a facility-to-facility supply chain relationship. For example, at functional block 103, the automated process sends an invitation to the battery manufacturer (a node) who has been identified by the smart phone manufacturer (another node) as one of the latter’s suppliers. In one implementation, the invitation being sent to the battery manufacturer can be an invitation for the battery manufacturer to provide information about the battery manufacturer’s respective suppliers (e.g., a chemical materials supplier), and this can be done by the battery manufacturer directly entering data into a form or by some other data input means.

At the next functional block 104, the automated process makes a determination as to whether the recipient (e.g., the battery manufacturer) verifies that the facility-to-facility supply chain relationship is true (e.g., that it is indeed the case that the battery manufacturer is a supplier to the smart phone manufacturer) and that the information provided by the smart phone manufacturer is correct (e.g., that the battery manufacturer does indeed supply batteries of the specified type as specified by the smart phone manufacturer). In some implementations, when the recipient has not so verified that the facility-to-facility supply chain relationship is true, the “No” branch is taken at functional block 104, and the mapping process terminates at functional block 105. However, it should be appreciated that in some other implementations, additional suitable attempts to verify the facility-to-facility supply chain relationship may be attempted prior to terminating the mapping process at functional block 105. When the recipient has so verified that the facility-to-facility supply chain relationship is true, the “Yes” branch is taken at functional block 104 and the process acknowledges at functional block 106 that the verification has taken place. Once verified, the recipient gains the ability to edit the entered information such as the material or product name and description, if required. Alternatively, the recipient can be allowed to edit the information before verification (for example, a supplier can edit its identification information, such as to use the official corporate name of the supplier’s company, before clicking on a “verify” button on a web based form/user interface).

The correspondence managed by the automated process also includes, in some implementations, an invitation to identify the recipient’s (e.g., the battery manufacturer’s) suppliers (e.g., a chemical materials supplier), which can be tailored to a certain scope of suppliers based on the objectives of the original mapping investigation. In some implementations, the recipient may enter or otherwise supply this information by utilizing a link to a web-based form included with the correspondence. This can be the same form that the recipient used to verify the information, and new fields/buttons on the form can be revealed once the verify button has been clicked. In this manner, it can be appreciated that further links in a facility-to-facility supply chain relationship are determined by the automated process.

Further, in some implementations, at block 106, the recipient may be prompted to enter or supply production information for the supplied product. For example, in some implementations, the recipient may enter data corresponding to whether the supplied product is unconstrained (that is, generally available for shipment without delay) or constrained in some manner (that is, generally requiring a lead time for production or otherwise constrained based upon an additional upstream supplier, packaging and shipping times, or other known constraint). It should be appreciated that suitable additional information relevant to the mapping of a facility-to-facility supply chain relationship may be requested and entered at block 106.

At functional block 107, the automated process makes a decision as to whether the recipient (e.g., the battery manufacturer) has responded to the supplier’s mapping invitation. When it is determined that the recipient has not so responded, the “No” branch is taken and control flows to functional block 108 and the mapping process terminates. However, it should be appreciated that in some other implementations, additional suitable requests for response the supplier’s mapping invitation may be attempted prior to terminating the mapping process at functional block 108. On the other hand, when is determined that the recipient has responded to the supplier’s mapping invitation, control flows to functional block 109. In functional block 109, the recipient responds to the invitation to identify its suppliers related to the original scope of the investigation and control loops back to functional block 102 where the recipient enters point of contact information for its suppliers, similar to the process described above. At functional block 102, the recipient enters the name and description of the material or product provided by each supplier, similar to the process described above.

In some implementations, the automated application uses the information and releases correspondence to each supplier (recipient) identified immediately above, and this then repeats automatically as new suppliers are added in response to new invitations in subsequent tiers. In this manner, it can be appreciated that further links and nodes in a facility-to-facility (or node-to-node) supply chain relationship can be determined and verified by the automated process.

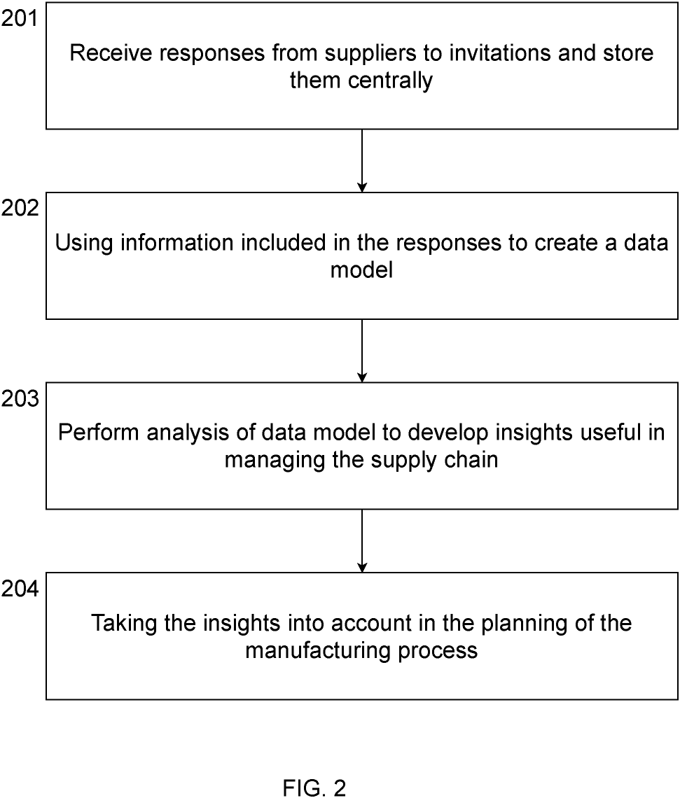

In FIG. 2, in some implementations of the disclosure, at functional block 201, the automated process receives the responses from suppliers to the invitations, and the responses are stored in a central repository or database. In some implementations, this can be done iteratively as the responses are received. In yet some other implementations, the storage could be done at one time after holding the responses in a batch queue.

As indicated at functional block 202, the automated process may, in some implementations, utilize the received and stored information included in the responses to create a data model indicative of one or more various aspects of the supply chain. For example, in some implementations a manufacturer (or supplier) may be most interested in determining the facility-to-facility supply chain path having the longest lead time (and/or variability) (this could be considered a critical path for the overall manufacture of an end product). In another example, the goal may be to identify the minimum capacity node across the whole supply chain network, e.g., multiple paths. In yet other implementations, a manufacturer (or supplier) may be most interested in determining the facility-to-facility supply chain path having the least number of constrained nodes, and the automated process may create the desired data model from the received and stored information to identify the desired supply chain path. In such situations, the automated process may create a data model from the received and stored information to identify the desired supply chain path. As can be appreciated, any one of several suitable data models may be created from the received and stored information, depending on the particular goal for the analysis.

At functional block 203, the automated process may, in some implementations, perform an analysis of the data model in order to develop insights useful in managing the supply chain. For example, in some implementations, the automated process may analyze the data model in order to identify the longest path within the supply chain based upon the supplied lead times and constraints. In yet other implementations, the automated process may analyze the data model to identify alternate nodes or supply chains that may be available to an ultimate manufacturer. As can be appreciated, any one of several suitable analyses may be performed upon the created data model.

The automated process may develop supply chain insights based upon the analysis performed upon the data model. For example, as illustrated at functional block 204, the automated process may take developed insights, once developed, into account when planning the manufacturing process for the overall product being manufactured. In this manner, the automated process may assist the manufacturer in reducing risk and vulnerabilities in the supply chain, improving efficiencies (lead time/capacity), improving reliability, reducing variability, improving agility (ability to respond to changes), developing contingency plans to reduce time-to-recover from an issue that occurred, and building reliable and flexible supply chain relationships between a variety of nodes. Alternatively, the insights can be presented to the manufacturer for the manufacturer to use them itself in influencing the manufacturing process.

In some implementations, information related to each supply chain tier can be recorded in a database during the automated process and time stamped. This supply chain data model can be used for subsequent analysis and visualizations in support of supply chain risk management processes.

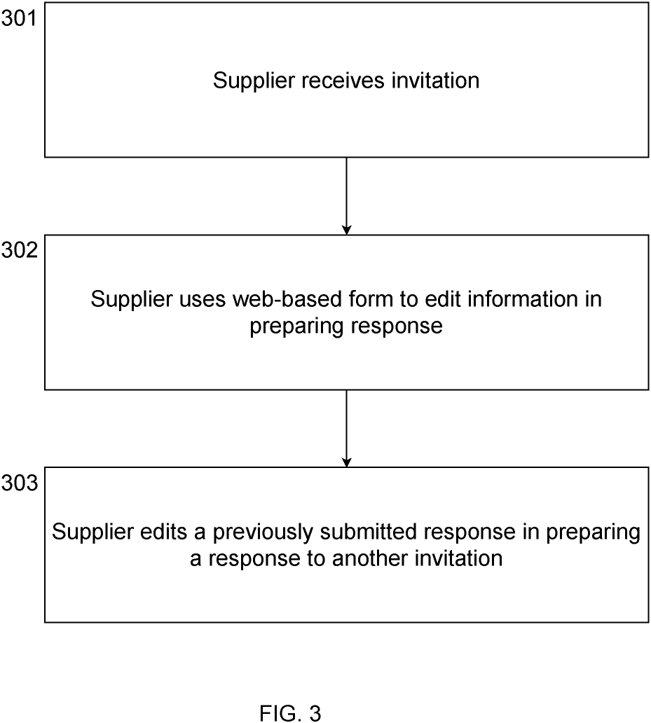

In some implementations, the automated process allows the recipient to use or edit previously submitted responses to invitations to reduce the burden of re-entering supplier and material information for subsequent invitations. In some implementations, the automated process uses several factors to identify new invitations that may be similar to previous invitations and these factors may include the same product or material name, the same email address (supplier), or the same overarching end product. In some implementations, time stamps can be evaluated to determine if new investigations are required. To achieve these goals, in some implementations, as shown in FIG. 3, at functional block 301, a supplier receives an invitation from the automated process. At functional block 302, the supplier uses a web-based form provided by the automated process to edit information in preparing the response. At functional block 303, the supplier may edit a previously submitted response when preparing a response to a subsequent invitation.

In some implementations, the automated process allows the recipient to initiate new invitations to their suppliers by exception. For example, suppose a supplier receives an invitation from a new customer, which is similar but slightly different from a previous investigation for a different customer. In such circumstance, the recipient may have the ability to 1) apply relationship data recently collected from a previous mapping investigation for a supplier or suppliers to the new invitation and 2) submit a new invitation to suppliers that have not previously been included or whose information may now be outdated. For example, the recipient can use the same web-based form (or user interface) that is used to verify the received information, as explained above, 1) to identify a direct match (same material/same end product) with a previous response that the recipient received from another customer for the same mapping project, 2) to select suppliers that a recipient has already identified in a previous response for another supply chain or project, or 3) to add new suppliers.

In some implementations, the automated process may only allow a recipient, or node, to have visibility of their respective upstream facility-to-facility supply chain relationships. In some implementations, nodes are unable to visualize or have access to the data of the downstream relationships of their customer’s customers. In this manner, supply chains can be visualized while preserving the confidentiality of each node’s customer list(s).

In some implementations, the automated process supports supply chain analysis based on: 1) item lead times and 2) node level constraints. In such implementations, the automated process identifies the most critical path of product/ manufacturing streams - that is, the longest path required to finish the end item. Node detail data can be utilized to estimate the maximum production capability at each node. As a result of such analysis, the minimum capacity node can be identified across all nodes related to the ultimate manufacture. It should be appreciated that a minimum capacity node constrains maximum production (bottleneck). Lead time and node level constraints across the entire system can be modeled for changes from day 1 to day 180, or any other desired and suitable time period.

In some implementations, the automated process enables upstream visibility and access to data of a recipient’s upstream facility-to-facility relationships to serve as an incentive to respond to invitations.

Likewise, in some implementations, the automated process prevents recipients from accessing data on the downstream facility-to-facility relationships, e.g., customer’s customer(s).

In some implementations, the automated process reduces the data entry burden related to responding to multiple invitations for the same or similar products and enables supplier mapping invitations by exception.

In some implementations, the automated process automatically records the supply chain model data as it is received and prompts users for recommended re-verification due to age of the data.

Finally, in some implementations, the automated process utilizes programming to analyze the supply chain model and dynamically estimate node level constraints and lead times over, for example, a 180-day period. For example, users can add increases in production capacity at various nodes during certain validity periods to model the impact in overall capability of the end item or product. This feature avoids having to utilize discrete event simulation software to achieve similar analytical insights. Discrete event simulation software is time consuming to use and program accordingly for supply chain analysis. The automated process described herein offers a simpler, efficient, and standardized approach to achieving the same analytical insights. Users do not have to add use expensive and difficult programming or configurations to enable the analysis.

Once the facility-to-facility supply chain data is collected and the data model populated, any of a plurality of data model visualization tools can be used to display the data model in a clear and highly visual manner. This is referred to below as a data illumination or visualization process.

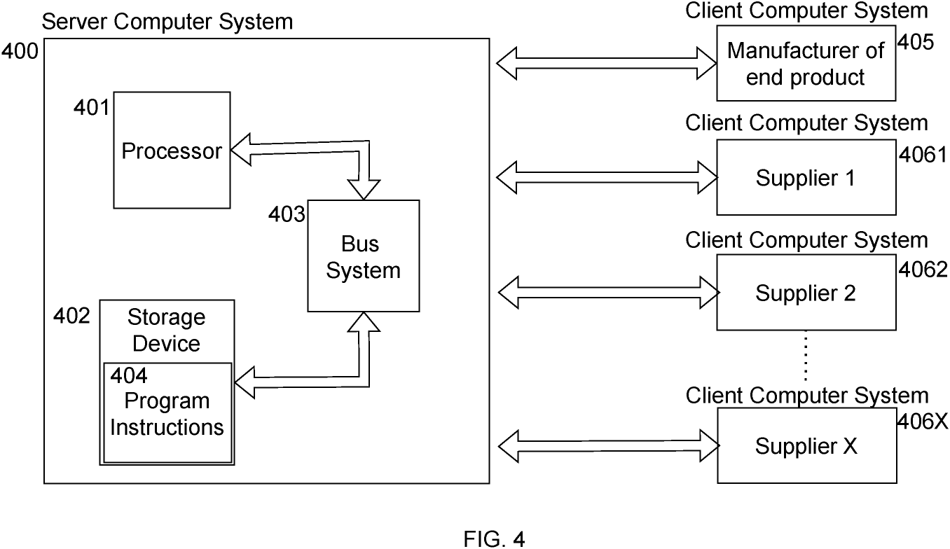

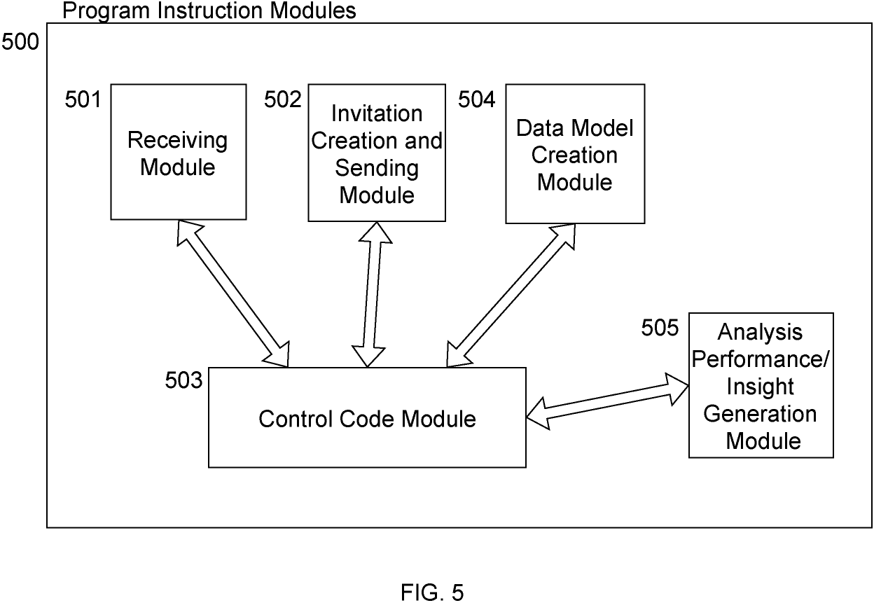

FIG. 4 is a functional block diagram illustrating a client/server architecture according to some implementations of the disclosure. In some implementations, a server computer system 400 is shown to include a processor 401, a storage device 402 and a bus system 403 (used to interconnect the processor and storage device, as well as to interconnect other elements of a server computer system which are not shown). In some implementations, the storage device 402 includes program instructions 404 for carrying out various functional blocks which will be described in more detail below with respect to FIG. 5. Processor 401 executes the program instructions 404 after accessing them via the bus system 403.

In some implementations, client computer systems 405, 4061, 4062 to 406X are also included in FIG. 4. These client systems interact with the server computer system 400 according to client/server communication protocols and techniques. Client computer system 405 can be used by the manufacturer of the overall end product. Client computer system 4061 can be used by a supplier or node (Supplier 1) who, for example, supplies components to the manufacturer of the overall end product. Client computer system 4062 can be used by a supplier or node (Supplier 2) who, for example, also applies components to the manufacturer of the overall end product. Other client computer systems can also be included to accommodate other suppliers or nodes (down to Supplier X which uses client computer system 406X). These other suppliers or nodes can either be suppliers of components to the manufacturer of the overall end product, or the suppliers could be suppliers who supply to a supplier who supplies to the manufacturer of the overall end product. This hierarchical node relationship could go on in such a way that many tiers of suppliers, or nodes, are accessing the server computer system 400 via client computer systems.

In some implementations, the client computer systems would be laptop computers, smart phones, tablets, or the like. The client computer systems would run a web browser application and access a web-based tool within the server computer system which can be coded by the program instructions 404.

FIG. 5 shows a functional block diagram of the program instruction modules 500, making up the program instructions 404 stored within the storage device 402 of the server computer system 400 of FIG. 4, according to some implementations of the disclosure.

Program instruction modules 500 include the following components, according to some implementations of the disclosure. Program instruction module 501 is a receiving module, which receives information from client computer system 405, used by the manufacturer of the end product. This received information includes an identity of the suppliers of components for that manufacturer’s end product. In some implementations, the received information may further include a description of the material(s)/component(s) that the respective supplier supplies to the manufacturer of the end product. Receiving module 501 also receives verification responses from the suppliers using the client computers, verifying that the information concerning the suppliers, as provided by the manufacturer, is correct. Further, in some implementations, receiving module 501 also receives responses to invitations (such responses including information regarding the identity of the supplier’s upstream suppliers and an identity of the material/component supplied by the upstream supplier).

Program instruction module 502 is, in some implementations, an invitation creation and sending module. The invitation creation and sending module 502 carries out the functionality of creating and sending an invitation to each supplier that the manufacturer of the end product has identified. The invitation invites the supplier to verify that the information regarding the supplier and of the material/component that the supplier supplies is correct, as previously described.

Program instruction module 503 is, in some implementations, a control module which includes code which links together the other modules. For example, when the receiving module 501 receives a verification from a supplier, verifying that the supplier information provided by the manufacturer, is correct, the control code module 503 then communicates with the invitation creation and sending module 502, to instruct the module 502 to send an invitation to the supplier who has verified that the supplier information provided by the manufacturer is correct. This latter invitation then invites the supplier receiving this invitation to identify the supplier’s suppliers as well as information regarding the material/component that the supplier supplies to the supplier (all according to the functional flow as detailed above with respect to FIG. 1). When the supplier responds to the invitation, the receiving module 501 receives such responses and communicates the responses with the control code module 503. The control code module also controls the repeating of the invitation sending procedure (as also shown in FIG. 1) to communicate with module 502 to send invitations further up the stream of suppliers, to provide very detailed information regarding the upstream supply chain.

Program instruction module 504 is, in some implementations, a data model creation module which creates a data model using the information received and collected under the control of the control code module 503 and as a result of the module 503′s interactions with the receiving module 501 and the invitation creation and sending module 502.

Program instruction module 505 is, in some implementations, an analysis performance/insight generation module, which performs data analysis on the data model which has been created by the data model creation module 504, and generates insights based on such analysis of the data model. The control code module 503 controls the interaction of the module 504 and the module 505 during this process.

### Example Time-Phased Supply Chain Capability Analysis

Once the data regarding the supply chain has been collected and a data model is populated, as was described above, this data model can be used to perform analytics to provide information to the manufacturer of the end product. In some implementations, the data model analytics may provide information including, for example, lead times and capacity information to help the manufacturer identify critical paths and supply chain bottlenecks. Such analytics allow the manufacturer to better understand how to manage the manufacturing process for the end product being manufactured. An overview of one exemplary supply chain data model, according to one implementation, will now be described. The overview also provides a step-by-step description of an example implementation of the time-phased lead time and output analysis methodology.

### Supply Chain Data Model Overview

In some implementations, the supply chain data model framework can be organized by the following key modeling elements:

Item: A single end item or product that can be produced by the supply chain.

Facility: A physical plant or facility where supply chain activities occur. Facilities can contain locations or serve as a general supply chain node.

Entities: A material, component, or product that moves within and from facilities.

Nodes: A location where a supply chain activity occurs, producing an entity that flows to another node at the same or a different facility, forming a chain. At its simplest, a node identifies an entity, e.g., material or component, that flows from one facility to another.

Node Detail: (Optional). Node Detail records are utilized to characterize performance capabilities at a particular node, including the ability to model more than one, non-identical production systems related to a unique node, as well as estimate time-phased capacity and lead time metrics. Node detail records are not required for simple facility-to-facility supply chain models. Node Detail data are summarized at the node level.

The system in some implementations can use these data elements to determine: 1) item lead times and 2) node level constraints. The system can identify the critical path of product/ manufacturing streams - the longest path required to finish the end item. Node Detail data can be utilized to estimate the maximum production capability at each node. Then, the minimum capacity node can be identified across all nodes related to the item, which constrains maximum production (bottleneck). Lead time and node level constraints across the entire system can be modeled for changes from Day 1 to 180.

### Methodology

This section describes the methodology, according to some implementations, which can be used to analyze the supply chain model automatically mapped by the application, as was described above. First, performance metrics are calculated for each node in the data model, including planned increases or step-ups in production capability at certain points in the future during a 180-day surge or accelerated demand period. These metrics can be used to identify node level capacity limitations or bottlenecks. Second, programming can be applied to determine all downstream relationships from every node in the supply chain data model, which can be used to calculate lead times. Third, the node level calculations (minimum output) and (lead times) can be used as inputs to estimate the overall capability of the final product or end item from Day 1 to 180. It should be appreciated that one or more of the materials and suppliers used in the examples below are fictional (e.g., wezandrium, turbinium, etc.) and are used merely for explanatory purposes. One of ordinary skill should understand that suitable real materials and suppliers would be used in an actual application of the disclosed implementations.

### Step 1 - Example Node Level Capability Calculations

Each node can be characterized as Unconstrained, Lead Time Only, or Constrained. Unconstrained nodes are filtered out of this step, while Lead Time Only nodes utilize the first of the following calculations. In some implementations, constrained nodes undergo the following four (4) calculations:

Node Lead Time (Days): Calculates the time for a node to complete a full production run and can be adjusted to account for non-production days during a production week, e.g., 5 production weekdays out of 7. This calculation applies to Lead Time Only and Constrained nodes.

### Inputs:

Cycle Time in minutes - Time in minutes to complete processing of a material, components, or part, not including equipment changeover or setup time.

Adjusted Batch Size - Adjusts the batch size based on two (2) elements - Batch Size and Node Capacity. If Node Capacity is greater than Batch Size, then 1; Else, Batch Size divided by Node Capacity.

Batch Size - A group of units produced at a node. Units within the batch can be manufactured for the full unit cycle time, and the batch remains at the location until all units in a batch have been manufactured before moving to the next node.

Node Capacity - Number of units that can be produced at one time. In some cases, production equipment may have the capacity to process more than one unit at a time.

TABLE 1

| Example | Batch Size | Node Capacity | Adjusted Batch Size |
|---|---|---|---|
| Wezandrium Vacuum Induction Melting (VIM) | 100 | 100 | 1 |
| Turbinium Vacuum Induction Melting (VIM) | 50 | 50 | 1 |
| ICE-9 Alloy Machining | 24 | 4 | 6 |
| Flexible PCB Production | 10 | 10 | 1 |

Changeover Time in minutes - Time in minutes to changeover or setup production equipment to produce the item, material, component or part.

Scheduled Time in minutes - Production minutes per day e.g., 480 minutes (8 hours per day). Formula: ((Cycle Time in minutes * Adjusted Batch Size) + Changeover Time in minutes) / (Scheduled Time in minutes * (Days of operation per Week / 7))

### Example:

Wezandrium VIM: ((50,400 min * 1) + 0 min) / (1440 min * (7 / 7)) = 35 days
Turbinium VIM: ((50,400 min * 1) + 0 min) / (1440 min * (7 / 7)) = 35 days
ICE-9 Alloy Machining: ((45 min * 6) + 480 min) / (960 min * (2 / 7)) = 2.7 days
Flexible PCB Production: ((60,480 min * 1) + 0 min) / (1440 min * (7 / 7)) = 42 days
Production Runs per Day: Calculates the maximum number of production runs per day at a node. In some implementations, this calculation applies to Constrained nodes only.

### Inputs:

Node Lead Time (Days) - See Step 1.
Formula: 1440 Mins / (Node Lead Time * 24 Hrs * 60 Mins)

### Example:

Wezandrium VIM: 1440 minutes / 50,400 minutes = 0.0286 production runs per day
Turbinium VIM: 1440 minutes / 50,400 minutes = 0.0286 production runs per day
ICE-9 Alloy Machining: 1440 minutes / 3,936.96 minutes = 0.3658 production runs per day
Flexible PCB Production: 1440 minutes / 60,480 minutes = 0.024 production runs per day
Maximum Daily Output: Maximum daily output of the end product or item for a production process. In some implementations, this calculation applies to Constrained nodes only.

### Inputs:

Production Runs per Day - See Step 2.

Batch Size - See Step 1; Note: This is not the Adjusted Batch Size.

Location Units - Number identical location units (Production Equipment).

Entity Conversion Factor - Number of units that have to be produced to equal one end item or product unit, e.g., 2 entities produced at a node are required to make 1 end item product. Formula: Production Runs per Day * Batch Size * Location Units / Entity Conversion Factor

### Example:

Wezandrium VIM: 0.0286 * 100 * 1/100 = 0.0286 units per day; Note: ECF is 100 - it takes 100 units at this node to make one finished part at the end of the supply chain.

Turbinium VIM: 0.0286 * 50 * 1 / 50 = 0.0286 units per day; Note: ECF is 50 - it takes 50 units at this node to make one finished part at the end of the supply chain.

ICE-9 Alloy Machining: 0.3658 * 24 * 1 / 1 = 8.784 units per day.

Flexible PCB Production: 0.0238 * 10 * 1 / 1 = 0.238 units per day.

Node Capacity: Quantity produced every production cycle. This calculation applies to Constrained nodes only.

### Inputs:

Node Lead Time (Days) - See Step 1.

Maximum Daily Output - See Step 3.

Formula: Node Lead Time (Days) * Maximum Daily Output

Wezandrium VIM: 35 days * 0.0286 units per day = 1 unit per cycle.

Turbinium VIM: 35 days * 0.0286 units per day = 1 unit per cycle.

ICE-9 Alloy Machining: 2.7 days * 8.784 units per day = 24 units per cycle.

Flexible PCB Production: 42 days * 0.238 units per cycle = 1 unit per cycle.

### Step 2 - Example Down Stream Relationship Mapping, Lead Time & Critical Path Analysis

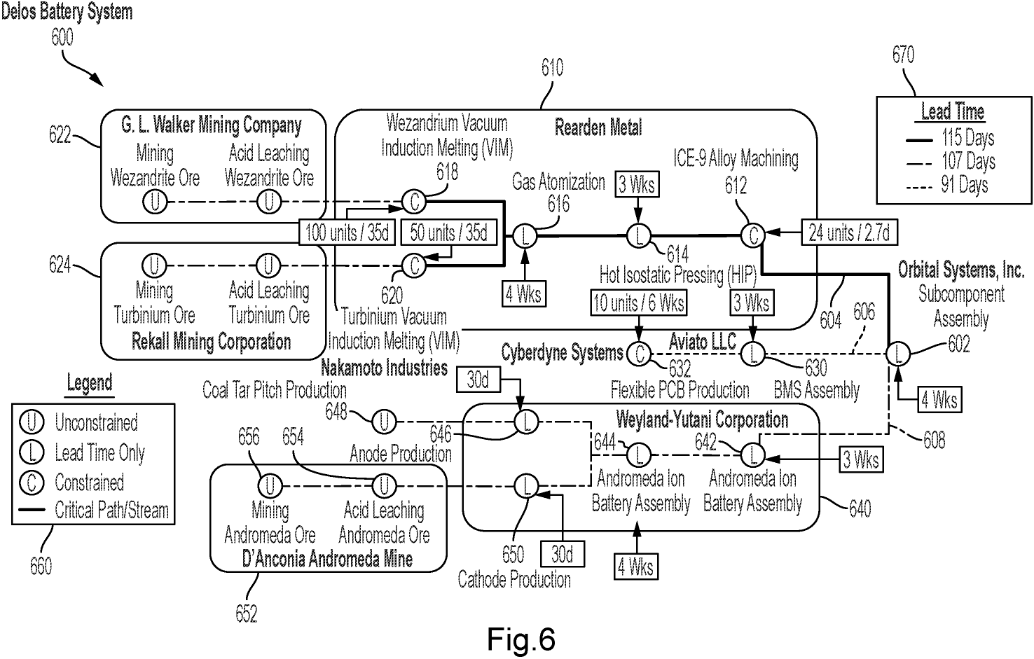

The system can identify the critical path of production - the longest path required to finish the end item. FIG. 6 shows a graphical example of a supply chain and manufacturing critical path.

As shown in FIG. 6, the example supply chain 600 is shown for manufacturing an example product, such as a battery system. In the example, the battery system is given the name “Delos Battery System” and Delos is the name of the figurative satellite system that uses the battery system.

In supply chain 600, a supply chain endpoint node 602 is shown, showing a subcomponent supplier, Orbital Systems, shown to require a lead time of four weeks for manufacturing a subcomponent after receiving components supplied from three separate suppliers (Rearden Metal 610 along path 604, Aviato LLC 630 along path 606, and Weyland-Yutani Corporation 640 along path 608). Path 604 shows a lead time path between Orbital Systems and Rearden Metal for a first component. Path 606 shows a lead time path between Orbital Systems and Aviato LLC for a second component. Path 608 shows a lead time path between Orbital Systems and Weyland-Yutani Corporation for a third component. Orbital Systems uses these three components in creating the subcomponent assembly shown at endpoint 602. Endpoint 602 shows the end of the supply chain. Box 660 is a Legend showing the types of nodes and paths. The path 604 is assumed to be a critical path (or stream).

Looking first at the critical path 604, Rearden Metal 610 has several nodes requiring lead times. Node 612 is an ICE (Innovative Custom Engineering)-9 alloy machining node. It is a constrained node capable of producing 24 units within a period of 2.7 days. Node 614 is a hot isostatic pressing (HIP) node, which is a Lead Time Only node having a three-week lead time. Node 616 is a Lead Time Only node which is a gas atomization node having a lead time of four weeks. Node 618 is a constrained node which is a Wezandrium Vacuum Induction Melting (VIM) node capable of producing 100 units every 35 days. Node 620 is a constrained node which is a Turbinium Vacuum Induction Melting (VIM) node. Node 620 represents a different VIM node at Rearden Metal 610, as compared to node 618, with a different constraint. Specifically, node 620 shows a capability of producing 50 units in 35 days.

G.L. Mining Company 622 and Rekall Mining Corporation 624 each includes unconstrained nodes referring to mining Wezandrite and Turbinium ores as well as unconstrained nodes referring to acid leaching of Wezandrite and Turbinium ores.

As can be appreciated, now that the supply chain and lead times have been determined, the total lead time can be calculated along path 604. The total lead time is the sum of respective lead times and constraints taken starting at node 602 and looking upstream: 28 days (at node 602) plus 3 days (at node 612) plus 21 days (at node 614) plus 28 days (at node 616) plus 35 days (at nodes 618 or 620) = 115 days. See the Lead Time Summary table 670 in FIG. 6 which lists the lead times for the three paths.

Now looking at path 606, an Aviato LLC node 630 shows a producer of BMS (battery management system) assemblies having a lead time of 3 weeks (21 days) for production. Further upstream, a constrained node 632 referring to Cyberdyne Systems, a flexible printed circuit board (PCB) producer, having a production of ten units every six weeks (42 days).

Calculating the total lead time of path 606: sum path 606 starting at node 602 and looking upstream: 28 days (at node 602) plus 21 days (at node 630) plus 42 days (at node 632) = 91 days.

Next, looking at path 608, Weyland-Yutani Corporation 640 is a supplier which has several production nodes with Lead Time Only data. Node 642 is a Lead Time Only node representing the Andromeda Ion Battery Assembly supplier having a lead time of 3 weeks. Node 644 is a second node representing the Andromeda Ion Battery Assembly supplier, also a Lead Time Only node, and this node shows a lead time of 4 weeks. The Weyland-Yutani Corporation also has an anode production node 646 and a cathode production node 650, each being a Lead Time Only node and each requiring a lead time of 30 days. Further upstream from node 646 is an unconstrained node 648 representing Nakamoto Industries, and involved in supplying coal tar pitch to Weyland-Yutani for anode production purposes. And further upstream from node 650 is the D′Anconia Andromeda Mine facility 652, an ore supplier to Weyland, for Weyland’s cathode production, and D′Anconia shows two unconstrained nodes 654 (an acid leaching node representing ore processing) and 656 (a mining node, representing ore mining).

Now, calculating the total lead time of path 608: sum path 608 starting at node 602 and looking upstream: 28 days (at node 602) plus 21 days (at node 642) plus 28 days (at node 644) plus 30 days (at nodes 646 or 650) = 107 days.

The automated process can use logic to iteratively identify all unique downstream node relationships. As shown in table 2, the system’s mapping methodology can capture each of these unique chains (start node-entity-end node) and can store the data accordingly.

TABLE 2

| | | |
|---|---|---|
| Start Node | Entity | End Node |
| Mining Wezandrite Ore | Wezandrite Ore | Acid Leaching Wezandrite Ore |
| Acid Leaching Wezandrite Ore | Wezandrium Hydroxide | Wezandrium Vacuum Induction Melting (VIM) |
| Wezandrium Vacuum Induction Melting (VIM) | Wezandrium chips | Gas Atomization |
| Gas Atomization | ICE-9 Alloy Powder | Hot Isostatic Pressing (HIP) |
| Hot Isostatic Pressing (HIP) | ICE-9Alloy NMS Battery Tray | ICE-9 Alloy Machining |
| ICE-9 Alloy Machining | Finished ICE-9 Alloy Battery Tray | Subcomponent Assembly |
| Subcomponent Assembly | Finished Power System | End |

Using table 2, the downstream relationship mapping logic searches for each downstream relationship and stops once no new records are appended. For each iteration, a record can be appended with the reference node, the next downstream node and entity in the relationship, and the level, which can be incremented each time by 1. Table 3 below shows the results of this iterative append process. Six (6) levels are identified for the first stream that starts with Mining Wezandrite Ore, as the reference node. This table configuration now shows that Mining Wezandrite Ore is related to Subcomponent Assembly, permitting node level capacity and lead time aggregation analysis.

TABLE 3

| Reference Node | Entity | Next Node | Level |
|---|---|---|---|
| Mining Wezandrite Ore | Wezandrite Ore | Acid Leaching Wezandrite Ore | 1 |
| Mining Wezandrite Ore | Wezandrium Hydroxide | Wezandrium VIM | 2 |
| Mining Wezandrite Ore | Wezandrium chips | Gas Atomization | 3 |
| Mining Wezandrite Ore | ICE-9 Alloy Powder | Hot Isostatic Pressing (HIP) | 4 |
| Mining Wezandrite Ore | ICE-9 Alloy NMS Battery Tray | ICE-9 Alloy Machining | 5 |
| Mining Wezandrite Ore | Finished ICE-9 Alloy Battery Tray | Subcomponent Assembly | 6 |

Table 4 shows the results of matching the weighted average lead time (several queries are used to calculate the weighted average lead time (composite lead time) for each node for each day, considering that nodes can have more than one type of processing system with different capacities and lead times) for each node of the critical path. Unconstrained nodes are filtered out of the analysis, so the starting node becomes Wezandrium Vacuum Induction Melting (VIM). These unconstrained nodes are included in the supply chain model and relationship mapping, but are not considered to be relevant to the lead time and capacity calculations. For example, there may be a signficant supply of Wezandrium Hydroxide that can be sourced quickly for Wezandrium Vacuum Induction Melting (VIM), so the user (for example, the manufacturer of the end product, or a supply chain analyst) may want to exclude these nodes from the lead time and capacity calculations.

TABLE 4

| Reference Node | Node | Entity | Lead Time (Days) |
|---|---|---|---|
| Wezandrium VIM | Wezandrium VIM | Wezandrium chips | 35 |
| Wezandrium VIM | Gas Atomization | Wezandrium chips | 28 |
| Wezandrium VIM | Hot Isostatic Pressing (HIP) | ICE-9 Alloy Powder | 21 |
| Wezandrium VIM | ICE-9 Alloy Machining | ICE-9 Alloy NMS Battery Tray | 2.7 |
| Wezandrium VIM | Subcomponent Assembly | Finished ICE-9 Alloy Battery Tray | 28 |

This relationship mapping allows the application to determine the time it takes to complete production at a node (Node Lead Time), finish production of the final product (Lead Time to Finish), and the Full Lead Time (Node Lead Time + Lead Time to Finish). As shown in FIG. 6 and as described above, the Lead Time to Finish after production is completed at Wezandrium VIM is 79.7 days (28 days at Gas Atomization, 21 days at Hot Isostatic Pressing (HIP), 2.7 days at ICE-9 Alloy Machining, and 28 days at Subcomponent Assembly). The Full Lead Time for Wezandrium VIM is 114.7 days (35 days of Node Lead Time + 79.7 days of Lead Time to Finish). Similarly, for the second stream starting at Flexible PCB Production, the lead time is 91 days (42 days + 21 days + 28 days). Finally, for the last stream starting at Cathode/ Anode Production (this last stream actually comprises of two separate streams -cathode and anode production; however, these separate nodes happen to have the same overall lead time because they have identical lead times of 30 days and the same downstream node relationships), the lead time is 107 days (30 days + 28 days + 21 days + 28 days). The Full Lead Time can be calculated for every node for every day from 1-180 days, and this value can change if any related node’s lead time changes over time (e.g., improves from a learning curve and decreases after a certain period of time). The Full Lead Time can be used to determine the output day for each node. Finally, the Full Lead Time can be then queried to determine the maximum lead time (critical path lead time) for the entire supply chain.

The next section describes how the relationship mapping and critical path lead time can be used to estimate supply chain output on a daily basis.

### Step 3 - Example Time-Phased Output Analysis

This analysis starts by determining the earliest day Subcomponent Assembly output can be achieved (115 days, based on the critical path analysis) and then by examining each constrained node record (4 total) on each day to see if each has any output on that day. This analysis results in the first table, as shown in the excerpt in FIG. 2. By Day 115, each constrained node will have output, and continue to have output everyday thereafter through 180 days. Table 5 includes the Maximum Daily Output as calculated in the previous section, which can be used to determine the node with the least amount of production output each day (Flexible PCB Production). In the table below, the lowest production rate is 0.24 and the Output Days progress through 180 days.

TABLE 5

| Output Day | Node | Output Qty | Maximum Daily Output |
|---|---|---|---|
| 115 | Wezandrium VIM | 1 | 0.03 |
| 115 | Turbinium VIM | 1 | 0.03 |
| 115 | ICE-9 Alloy Machining | 24 | 8.78 |
| 115 | Flexible PCB Production | 10 | 0.24 |
| 116 | Wezandrium VIM | 1 | 0.100 |
| 116 | Turbinium VIM | 1 | 0.167 |
| 116 | ICE-9 Alloy Machining | 24 | 0.250 |
| 116 | Flexible PCB Production | 10 | 0.083 |
| 117 | Wezandrium VIM | 1 | 0.100 |
| 117 | Turbinium VIM | 1 | 0.167 |
| 117 | ICE-9 Alloy Machining | 24 | 0.250 |
| 117 | Flexible PCB Production | 10 | 0.083 |

Table 5 can then queried to determine the node with the minimum daily output quantity by output day. Often, there may be more than one node with the same, minimum output quantity on a given day. In some implementations, as in the shown case, the queries select only the first unique node with the same lowest rate of production on the same Output Day. In table 6 below, the Output Days progresses through to 180 days.

TABLE 6

| Output Day | Node | Output Qty | Maximum Daily Output |
|---|---|---|---|
| 115 | Flexible PCB Production | 10 | 0.24 |
| 116 | Flexible PCB Production | 10 | 0.24 |
| 117 | Flexible PCB Production | 10 | 0.24 |
| 118 | Flexible PCB Production | 10 | 0.24 |
| 119 | Flexible PCB Production | 10 | 0.24 |
| 120 | Flexible PCB Production | 10 | 0.24 |

Since flexible PCB production each day is below 1 (0.24 units per day), the application uses programming to evaluate each record from Day 115 to 180 and calculate production batches. On Day 115, Flexible PCB Production will have output of 10 units (appended into a capability table). A variable can be used to calculate the Next Output Day (Day 115 + Node Lead Time of 42 days = Day 157). Once the record for Day 157 is reached in the sequence, the Output Qty will be appended again as having output of 10 units. Otherwise, the Output Qty will be zero. For each day, a Cumulative Output Qty can also appended into the table, as illustrated in Table 7.

TABLE 7

| Output Day | Node | Output Qty | Cumulative Output Qty |
|---|---|---|---|
| 115 | Flexible PCB Production | 10 | 10 |
| 157 | Flexible PCB Production | 10 | 20 |

The capability table can now be used to visualize the maximum time-phased output of the final product from Day 1 to 180, based on the underlying supply chain data model.

Finally, users can model the impact of adding additional production output at any node by adding additional Node Detail records with specific validity periods, e.g., the production system at Node X produces 100 units per day from Day 1-40, and then shifts to 150 units on days 41-180. Likewise, users can also model the impact of nodes that get faster over time, e.g., learning curves.

The flowchart and block diagram in the figures and example tables show the functionality and operation of possible implementations of systems, methods and computer programs, according to implementations of the present disclosure. Each block in the flow chart or block diagram may represent a module segment or portion of code, which comprises one or more executable instructions for implementing the specified logical function or functions. It should be noted that in alternative implementations, the functions may occur out of the order indicated in the figures. This can include two or more blocks being executed simultaneously as opposed to one after the other, or some can be executed in reverse order.

It should be appreciated that the systems and methods described herein provide for new and innovative ways to collect information from suppliers in a manufacturing supply chain. These systems and methods implementing the functions of the program instruction modules 501 to 505 are technological improvements that result in faster and more efficient computation. Previously known systems and methods for collecting and processing this supply chain information could take hours or days to compute appropriate solutions. Moreover, the complete supply chain information was not available for analysis. Thus, the program instruction modules 501 to 505 clearly improve the functioning of a computer used to collect and process the supply chain information because of the enormous increase in computational efficiency. This enormous increase in computational efficiency means that a computer generating and processing this supply chain information vastly reduces its processor and memory usage. This reduction in processor and memory usage also means vastly lower power consumption.

The flowchart and block diagram in the figures show the functionality and operation of possible implementations of systems, methods and computer programs, according to certain implementations of the present disclosure. Each block in the flow chart or block diagram may represent a module segment or portion of code, which comprises one or more executable instructions for implementing the specified logical function or functions. It should be noted that in alternative implementations, the functions may occur out of the order indicated in the figures. This can include two or more blocks being executed simultaneously as opposed to one after the other, or some can be executed in reverse order.

Each block can be implemented by special purpose hardware-based systems that perform the specified functions or acts, or combinations of specialized hardware and computer instructions (software).

The present disclosure is not to be limited in terms of the particular implementations described in this disclosure, which are intended as illustrations of various implementations. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C″ would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or implementations of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the described implementations. For example, various forms of the method/process flows shown above may be used, with operations or steps re-ordered, added, or removed. Accordingly, other implementations are within the scope of the following claims.

1. A computer-implemented method of managing a manufacturing supply chain, related to the manufacture of an end product, comprising, at the server computer system:
receiving from a client computer system used by a manufacturer of the end product, first information including contact information regarding a plurality of suppliers, each of which supplies a specific component used in the manufacture of the end product, and second information regarding the specific component supplied by each respective supplier;
using the first information to automatically and electronically communicate with a client computer system used by each of the plurality of suppliers, to invite each of the plurality of suppliers to verify that the first and second information received is correct;
when at least one of the plurality of suppliers has verified, via its respective client computer system, that the first and second information as correct, sending an invitation to the client computer system used by at least one supplier, inviting the at least one supplier to provide third information including contact information regarding a plurality of suppliers, each of which supplies to the at least one supplier, a specific component used in the manufacture of the component that the at least one supplier supplies to the manufacturer of the end product, and fourth information regarding the specific component supplied to the at least one supplier, by its respective supplier;
receiving at least one response to the invitation or invitations;
repeating the sending of invitations based on contents of the at least one response and receiving responses to respective invitations;
using information included in the responses to create a data model; and
performing analysis of the data model to develop insights useful in managing the supply chain.

2. The method of claim 1, wherein a supplier responds to an invitation using a web-based form which is part of an application which carries out the method.

3. The method of claim 1, wherein new invitations are sent automatically as new suppliers are added.

4. The method of claim 1, wherein the data model is stored in a database and is timestamped.

5. The method of claim 2, wherein the application allows the supplier to use the web-based form to edit information in preparing a response to an invitation.

6. The method of claim 2, wherein the application allows the supplier to edit a previously submitted response to an invitation in preparing a response to another invitation.

7. The method of claim 6, wherein the application uses a plurality of factors to determine if a new invitation is similar to a previously submitted response to an invitation, including any of an email address of a receiver of an invitation, an identity of a product or material, and an identity of the end product, and prompts the supplier to edit a previously submitted response to an invitation when a new invitation is determined to be similar to a previously received invitation.

8. The method of claim 2, wherein the application allows a supplier to have visibility of that supplier’s upstream supplier relationships and prevents a supplier from having visibility of that supplier’s downstream relationships.

9. A computer system for managing a manufacturing supply chain, related to the manufacture of an end product, the computer system comprising:
a bus system;
a storage device connected to the bus system, wherein the storage device stores program instructions; and
a processor connected to the bus system, wherein the processor executes the program instructions to carry out a computer-implemented method comprising:
receiving from a client computer system used by a manufacturer of the end product, first information including contact information regarding a plurality of suppliers, each of which supplies a specific component used in the manufacture of the end product, and second information regarding the specific component supplied by each respective supplier;
using the first information to automatically and electronically communicate with a client computer system used by each of the plurality of suppliers, to invite each of the plurality of suppliers to verify that the first and second information received is correct;
when at least one of the plurality of suppliers has verified, via its respective client computer system, the first and second information as correct, sending an invitation to the client computer system used by at least one supplier, inviting the at least one supplier to provide third information including contact information regarding a plurality of suppliers, each of which supplies to the at least one supplier, a specific component used in the manufacture of the component that the at least one supplier supplies to the manufacturer of the end product, and fourth information regarding the specific component supplied to the at least one supplier, by its respective supplier;
receiving at least one response to the invitation or invitations;
repeating the sending of invitations based on contents of the at least one response and receiving responses to respective invitations;
using information included in the responses to create a data model; and
performing analysis of the data model to develop insights useful in managing the supply chain.

10. The computer system of claim 9, wherein a supplier responds to an invitation using a web-based form which is part of an application.

11. The computer system of claim 9, wherein new invitations are sent automatically as new suppliers are added.

12. The computer system of claim 9, wherein the data model is stored in a database and is timestamped.

13. The computer system of claim 10, wherein the application allows the supplier to use the web-based form to edit information in preparing a response to an invitation.

14. The computer system of claim 10, wherein the application allows the supplier to edit a previously submitted response to an invitation.

15. The computer system of claim 14, wherein the application uses a plurality of factors to determine if a new invitation is similar to a previously submitted response to an invitation, including any of an email address of a receiver of an invitation, an identity of a product or material and an identity of the end product and prompts the supplier to edit a previously submitted response to an invitation when a new invitation is determined to be similar to a previously received invitation.

16. The computer system of claim 10, wherein the application allows a supplier to have visibility of that supplier’s upstream supplier relationships and prevents a supplier from having visibility of that supplier’s downstream relationships.

17. A system for managing a manufacturing supply chain, the system comprising:
at least one processor; and
at least one memory that stores computer executable instructions, wherein, when the computer executable instructions are executed by the at least one processor, the at least one processor is configured to:
receive from a first node a plurality of first information and a plurality of second information associated with a plurality of other nodes, wherein the plurality of first information comprises contact information associated with the plurality of other nodes, wherein the plurality of second information comprises at least one component used in the manufacture supplied by the plurality of other nodes;
automatically and electronically communicate with the plurality of other nodes, using the plurality of first information, to invite the plurality of other nodes to verify that first and second information is correct;
send an electronic invitation to at least one of the plurality of other nodes requesting that the at least one of the plurality of other nodes provide a third information and a fourth information, wherein the third information comprises contact information of at least one new node, wherein the at least one new node provides a component used in the manufacture of the component that the at least one of the plurality of other nodes supplies to first node, and the fourth information comprises a component supplied to the at least one of the plurality of other nodes by the at least one new node;
create a data model based on the first information, the second information, the third information, and the fourth information;
determine a minimum capacity node based on the data model; and
adjust a supply chain input at a node based on the determined minimum capacity node.

18. The computer system of claim 17, wherein the computer executable instructions further cause the at least one processor to collect lead time information from a node specifying a time required for the node to complete an entire production run, and to include the collected lead time information in the data model.

19. The computer system of claim 17, wherein the computer executable instructions further cause the at least one processor to collect capacity information from a node regarding a number of units that can be produced within a unit of time or time unit interval, and to include the collected capacity information in the data model.

20. The computer system of claim 18, wherein the computer executable instructions further cause the at least one processor to calculate a total lead time along a path in the supply chain.
